(19) United States
(12) Patent Application Publication
(10) Pub. No.: US 2007/0185420 A1
(43) Pub. Date: Aug. 9, 2007

(54) Massage apparatus with a controller device

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD., Chai Wan (HK)

(21) Appl. No.: 11/347,710

(22) Filed: Feb. 3, 2006

(51) Int. Cl. A61H 1/00

(52) U.S. Cl. 601/72; 601/67; 601/70

(57) ABSTRACT

A massage apparatus comprising a hand-held controller device adapted to be operatively engaged to one or more massage actuators is disclosed. The controller device comprises a controller body including a control panel for controlling a massage actuator operatively engaged to controller device through a cable. The cable of the massage actuator includes a screw nut and a DC jack adapted to operatively engage the massage actuator to the controller device, wherein the controller body is adapted to disengage the cable of one massage actuator in order to engage the cable of another massage actuator to the controller body.

### FIELD

The present document relates to a massage apparatus, and more particularly to a massage apparatus having a controller device.

### SUMMARY

In one embodiment, a massage apparatus comprises a controller device, the controller device including a body having a control panel operatively associated with a power source, and a plurality of massage actuators, each of the plurality of massage actuators being adapted to provide a massage function and including a vibratory component for providing the massage function, each of the plurality of massage actuators having a cable being adapted to permit engagement or disengagement of any one of the plurality of massage actuators to or from the controller device.

In another embodiment, the massage apparatus comprises a controller device, the controller device including a body having a control panel for controlling the operation of the massage device with the control panel being operatively associated with a power source, and a massage actuator for providing a massage function, the massage actuator including a vibratory component for providing the massage function and a cable adapted for operative engagement with the controller device for controlling the operation of the massage actuator, wherein the controller device is adapted to permit operative disengagement of the massage actuator as well as permit operative engagement of another massage actuator to said controller device.

In yet another embodiment, the massage apparatus comprises a controller device, the controller device including a body having a control panel for controlling the operation of the massage apparatus, the control panel being operatively associated with a power source, and a plurality of massage actuators for providing a massage function, each of the plurality of massage actuators being adapted to permit operative engagement with the controller device for providing the massage function.

In another embodiment, a method for exchanging massage actuators comprises:

a) providing a massage apparatus comprising a controller device, the controller device including a body having a control panel operatively associated with a power source, and a massage actuator for providing a massage function, the massage actuator including a vibratory component for providing the massage function and a cable operatively engaged to the controller device;

b) disengaging the cable from the controller device of the massage apparatus; and

c) engaging a cable from another massage actuator to the controller device.

Implementation of the above embodiments may include one or more of the following features:

The cable includes a DC jack for operative engagement with the controller device.

The cable further includes a screw nut for engaging the cable to said controller device.

The vibratory component includes a motor having a rotatable shaft operatively engaged to an eccentric mass for generating the vibration function.

The cable is flexible.

The cable includes a DC jack and a screw nut arrangement for operatively engaging the controller device to the massage actuator.

The body further includes a threaded circular portion adapted to engaged the screw nut when operatively engaging the controller device to the massage actuator.

The body including an upper casing engaged to a lower casing.

A sealing element is interposed between the upper casing and the lower casing.

The body includes electronics in operative association with the control panel, the electronics being operatively associated with the cable when the cable is operatively engaged to the controller device.

The step of disengaging the cable from the controller device includes rotating the screw nut and disengaging the DC jack and the screw nut from the controller device.

The another massage actuator includes another cable having another screw nut and another DC jack.

The step of engaging the cable from the another massage actuator to the controller device includes rotating the another screw nut and engaging the another DC jack from the controller device.

Additional features of the invention will be set forth in the description which follows or will become apparent to those skilled in the art upon examination of the drawings and detailed description which follows.

### BRIEF DESCRIPTION OF THE DRAWINGS

FIG. 1 is a perspective view of the massage apparatus showing alternative massage actuators;

FIG. 2 is an exploded view of the massage apparatus showing the controller device and massage actuator;

FIG. 3 is an exploded view of the controller device;

FIG. 4 is another exploded view of the controller device; and

FIG. 5 is an enlarged partial cross-sectional view of the massage actuator engaged to the controller device.

Corresponding reference characters indicate corresponding elements among the view of the drawings.

### DETAILED DESCRIPTION

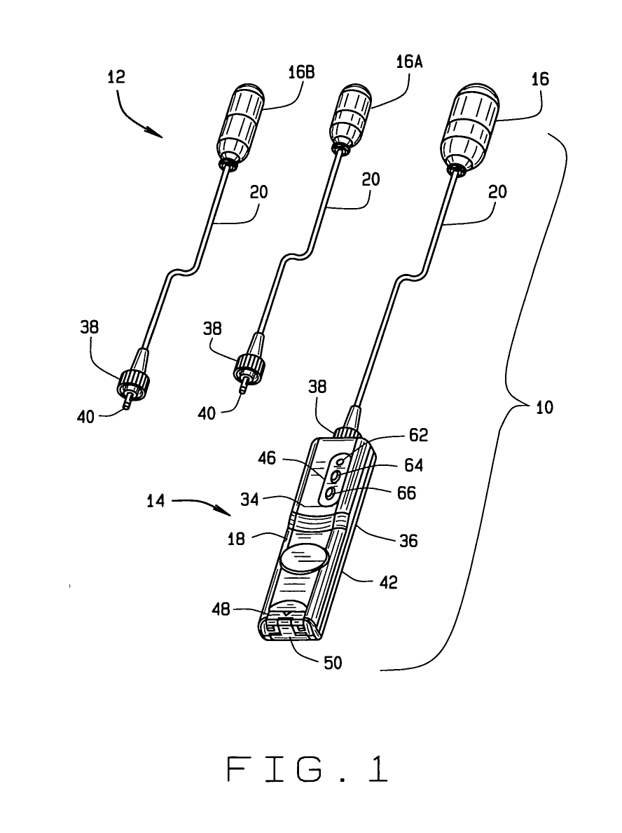

Referring to the drawings, an embodiment of the massage apparatus is illustrated and generally indicated as 10 in FIG. 1. The massage apparatus 10 may include a controller device 14 adapted to operatively engage a massage actuator 12. As shown, the massage actuator 12 may include a vibratory component 16 operatively associated with the controller device 14 through a flexible cable 20. In one embodiment, the controller device 14 may be adapted to permit operative disengagement of one massage actuator 12 having a vibratory component 16 from the controller device 14 and permit operative engagement of another massage actuator 12 to the controller device 14 having a different vibratory component 16A or 16B. Although three possible embodiments of the massage actuator 12 are illustrated herein, massage actuators 12 having different types of vibratory components 16 for operative engagement with the controller device 14 are contemplated.

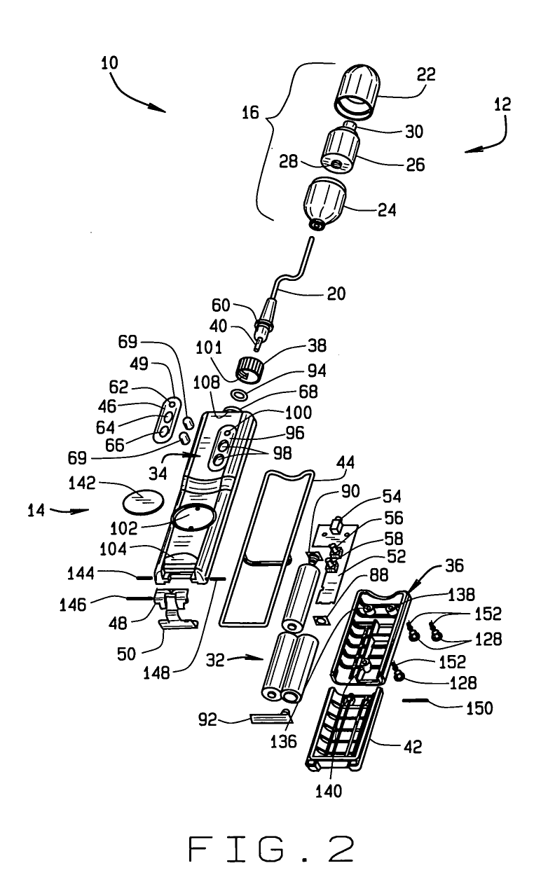

As further shown, the flexible cable 20 may include a screw nut 38 with a center hole 101 (FIG. 2) that slides over a DC jack 40 to operatively engage the massage actuator 12 to the controller device 14. In this manner, the massage actuator 12 may be operatively engaged to the controller device 14 by engaging the screw nut 38 to the controller device 14 that operatively associates the DC jack 40 with the controller device 14 for controlling the vibratory component 16 as shall be discussed below.

Referring to FIG. 2, the vibratory component 16 may include an upper casing 22 adapted to engage a lower casing 24 that houses a motor 26. The motor 26 may be adapted to rotate a motor shaft 28 for spinning an eccentric mass 30 mounted on motor shaft 28 that provides a massage function when activated by the controller device 14.

Referring to FIGS. 1 and 2, the controller device 14 may include a controller body 18 having a front casing 34 adapted to engage a back casing 36 with a sealing element 44 engaged between the engaged front and back casings 34, 36 for providing a water-tight seal to the controller body 18. The controller device 14 may further include a control panel 46 operatively associated with a microprocessor (not shown) for controlling the operation of the vibratory component 16 through flexible cable 20.

The control panel 46 may include an operational indicator 62 and membrane switches 64, 66 defined on a transparent plastic overlay 49 that communicates with a push button 56 and push button 58 which are operatively engaged with a printed circuit board 52. In particular, the plastic overlay 49 may be engaged inside a recess 96 defining holes 98 and aperture 100 such that the operational indicator 62 corresponds with aperture 100 while membrane switches 64 and 66 correspond with holes 98, respectively.

The aperture 100 may communicate with a light emitting diode (not shown) operatively associated with the printed circuit board 52 such that a visual indication is given to the user through operational indicator 62 related to the operational state of the massage actuator 12. As noted above, the printed circuit board 52 includes push buttons 56 and 58 that may communicate through holes 98 for actuation by respective membrane switches 64 and 66 that control various operations of the massage actuator 12. Each of the push buttons 56 and 58 are engaged to switch caps 69 that facilitate the respective actuation of push buttons 56 and 58 by the membrane switches 64 and 66.

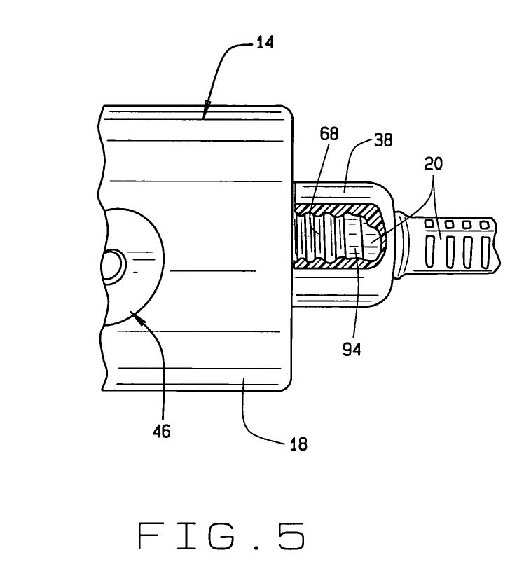

As further shown, the printed circuit board 52 may include a power socket 54 that is operatively associated with a circular portion 68 having external threads 108 defined by controller body 18. Referring to FIG. 5, this arrangement of the circular portion 68 and power socket 54 is adapted to operatively engage the DC jack 40 to the controller device 14 when engaging the screw nut 38 of the flexible cable 20 to the circular portion 68 of the controller body 18. In one embodiment, the DC jack 40 may include a circular slot 60 that may be engaged to a resilient rubber ring 94 in order to provide a water-tight seal between the DC jack 40 and the circular portion 68 when the screw nut 38 is tightened to the circular portion 68.

The top and back casings 34, 36 collectively house batteries 32 that provide power to the massage apparatus 10. The batteries 32 may be operatively engaged to a conductive plate 88 as well as conductive plates 90 and 92 that each have a metallic spring for contacting batteries 32. The conductive plates 88, 90 and 92 are secured to the top casing 34 and may be electrically connected to printed circuit board 52 for defining an electrical circuit. During assembly, the back casing 36 along with the printed circuit board 52 may be secured to the top casing 34 by a set of screws 152 inserted through holes 136, 138 and 140, respectively. In addition, holes 136, 138 and 140 may be adapted to receive resilient rubber plugs 128 for providing a water tight seal at holes 136, 138 and 140 and for encasing screws 152 after the top casing 34 is engaged to the bottom casing 36.

In one embodiment, the top casing 34 may define an indentation 102 sized and shaped to affix a name plate 142 having a mark or identity of the manufacturer on the massage apparatus 10.

To encase the batteries 32 within the massage apparatus 10, a battery cover 42 may have one end pivotally engaged to the back casing 36 by a pin 150 while another end of battery cover 42 is adapted to engage a clamping arrangement for opening and closing the battery cover 42 as shall be discussed below.

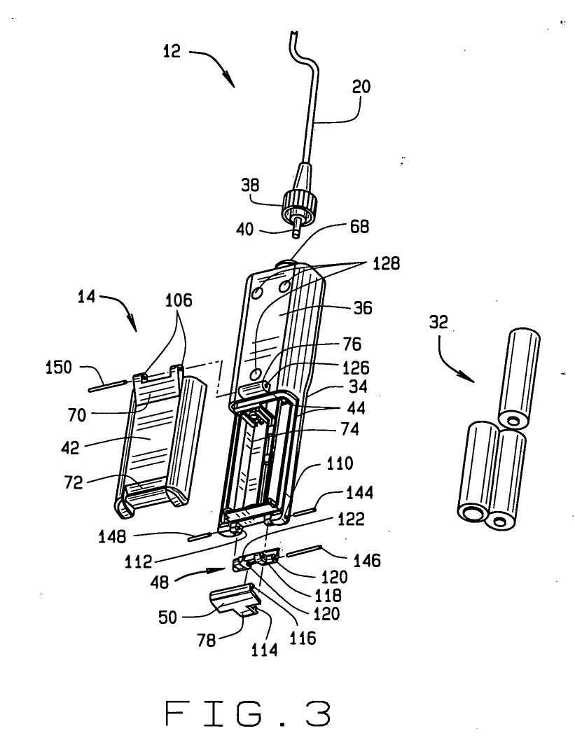

Referring to FIG. 3, the upper half of the controller body 18 may be permanently covered by securing the back casing 36 to the front casing 34 using screws 152, while the lower half of the controller body 18 may be removably covered by battery cover 42. As shown, the battery cover 42 may include a hinge arm 70 that defines hinge holes 106 adapted to engage a pin 150 that pivotally connects the battery cover 42 to the back casing 36. In particular, the back casing 36 may include a hinge block 76 defining a hole 126 adapted to be in registration with holes 106 of battery cover 42 and receive pin 150 therethrough for pivotally connecting the hinge arm 70 to the hinge block 76 such that one end of the battery cover 42 may rotate about pin 150.

As further shown, the battery cover 42 may define an undercut recess 72 adapted to engage a flange 116 defined by a locking hook 50. The locking hook 50 also defines an extension 78 that may include a hole 114 with locking hook 50 being adapted to engage one end of battery cover 42 to the front casing 34. In addition, the locking hook 50 may be pivotally connected to a clamping arm 48. Specifically, clamping arm 48 may define holes 118, 120 and 122 for pivotally connecting the clamping arm 48 to the locking hook 50 and front casing 34. Hole 114 of locking hook 50 is adapted to be in registration with holes 120 of clamping arm 48 such that a pin 146 can be inserted through holes 114 and 120, thereby providing a pivoting connection between the locking hook 50 and clamping arm 48. In addition, front casing 34 may define holes 110 and 112 adapted to be in registration with holes 118 and 122, respectively, of clamping arm 48 such that a pin 144 may be inserted through holes 110 and 118, while a pin 148 may be inserted through holes 112 and 122, thereby providing a pivoting connection between the clamping arm 48 and front casing 34. In addition, the front casing 34 may define an indentation 104 at one end that provides a recessional space for placing the clamping arm 48 in a locking position. This structural arrangement may then provide a toggle arrangement for securing the battery cover 42 to controller device 14.

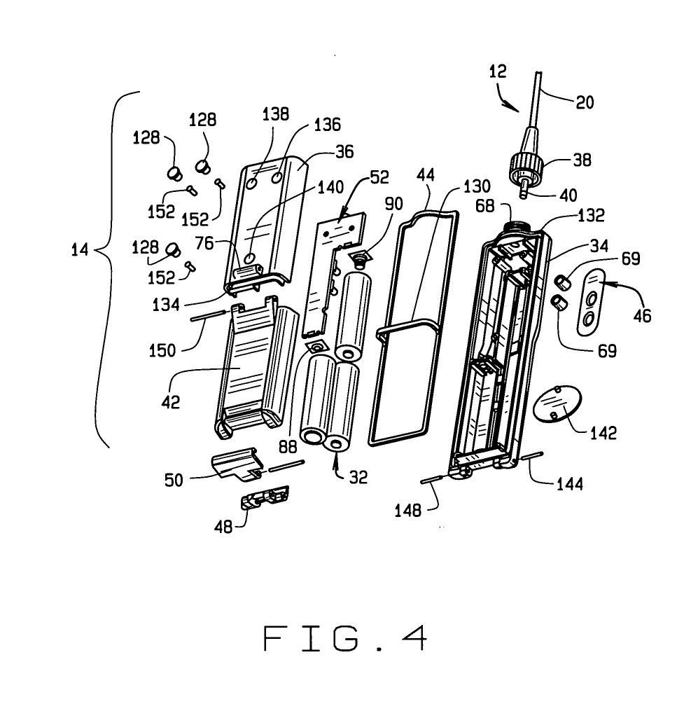

As further shown, front casing 34 may define a battery chamber 74 adapted to receive a plurality of batteries 32 for providing a power source for massage apparatus 10. A sealing element 44 may be adapted to engage a peripheral slot 132 (FIG. 4) defined by the battery chamber 74 such that a water tight seal is provided between the battery cover 42 and the front and back casings 34, 36.

Referring to FIG. 4, back casing 36 may define a slot 134 adapted to engage a bridge portion 130 of sealing element 44 when the back casing 36 is secured to the front casing 34 in order to provide a water tight seal.

In one embodiment, a method of exchanging one massage actuator 12 having a vibratory component 16 for another massage actuator 12 having a different vibratory component 16A or 16B may include the steps of disengaging the cable 20 of vibratory component 16 by rotating the screw nut 38 and disengaging the DC jack 40 and screw nut 38 from the circular portion 68 of the controller body 18. Once disengaged, another massage actuator 20, having either vibratory component 16A or 16B, may then be engaged to the controller body 18 by engaging the DC jack 40 of another massage actuator 20 to the circular portion 68 and then rotating the screw nut 38 such that the screw nut 38 becomes engaged to the circular portion 68. It is contemplated that the above embodiment is not restricted to vibratory components 16A or 16B and that a massage actuator 20 having other types of vibratory components 16 may be utilized.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in the claims appended hereto.

What is claimed is:

1. A massage apparatus comprising:
a controller device, said controller device including a body having a control panel operatively associated with a power source, and
a plurality of massage actuators, each of said plurality of massage actuators being adapted to provide a massage function and including a vibratory component for providing said massage function, each of said plurality of massage actuators having a cable being adapted to permit engagement or disengagement of any one of said plurality of massage actuators to or from said controller device.

2. The massage apparatus according to claim 1, wherein said cable includes a DC jack for operative engagement with said controller device.

3. The massage apparatus according to claim 1, wherein said cable further includes a screw nut for engaging said cable to said controller device.

4. The massage apparatus according to claim 1, wherein said vibratory component includes a motor having a rotatable shaft operatively engaged to an eccentric mass for generating said vibration function.

5. The massage apparatus according to claim 1, wherein said cable is flexible.

6. The massage apparatus according to claim 1, wherein said cable includes a DC jack and a screw nut arrangement for operatively engaging said controller device to said massage actuator.

7. The massage apparatus according to claim 3, wherein said body further includes a threaded circular portion adapted to engaged said screw nut when operatively engaging said controller device to said massage actuator.

8. The massage apparatus according to claim 1, wherein said body including an upper casing engaged to a lower casing.

9. The massage apparatus according to claim 8, wherein a sealing element is interposed between said upper casing and said lower casing.

10. The massage apparatus according to claim 1, wherein said body includes electronics in operative association with said control panel, said electronics being operatively associated with said cable when said cable is operatively engaged to said controller device.

11. A massage apparatus comprising:
a controller device, said controller device including a body having a control panel for controlling the operation of the massage device, said control panel being operatively associated with a power source, and
a massage actuator for providing a massage function, said massage actuator including a vibratory component for providing said massage function and a cable adapted for operative engagement with said controller device for controlling the operation of said massage actuator, wherein said controller device is adapted to permit operative disengagement of said massage actuator as well as permit operative engagement of another of said massage actuator to said controller device.

12. A massage apparatus comprising:
a controller device, said controller device including a body having a control panel for controlling the operation of the massage apparatus, said control panel being operatively associated with a power source, and
a plurality of massage actuators for providing a massage function, each of said plurality of massage actuators being adapted to permit operative engagement with said controller device for providing the massage function.

13. A method for exchanging massage actuators comprising:
a) providing a massage apparatus comprising a controller device, said controller device including a controller body having a control panel operatively associated with a power source, and a massage actuator for providing a massage function, said massage actuator including a vibratory component for providing said massage function and a cable operatively engaged to said controller device, said vibratory component in operative association with a DC jack through said cable, said DC jack being adapted to operatively associate said vibratory component with said controller device, said cable including a screw nut adapted to engage said cable to said controller body;
b) disengaging said cable from said controller device of said massage apparatus; and
c) engaging a cable from another massage actuator to said controller device.

14. The method according to claim 13, wherein said step of disengaging said cable from said controller device includes rotating said screw nut and disengaging the DC jack and said screw nut from said controller device.

15. The method according to claim 13, wherein said another massage actuator includes another cable having another screw nut and another DC jack.

16. The method according to claim 15, wherein said step of engaging said cable from said another massage actuator to said controller device includes rotating said another screw nut and engaging said another DC jack from said controller device.
